(19) United States
(12) Patent Application Publication
(10) Pub. No.: US 2025/0249471 A1
(43) Pub. Date: Aug. 7, 2025

(54) SAFETY TOP FOR SPRAY BOTTLE

(71) Applicant: Jeremiah J. Buck, Wheat Ridge, CO (US)

(72) Inventor: Jeremiah J. Buck, Wheat Ridge, CO (US)

(21) Appl. No.: 18/430,605

(22) Filed: Feb. 1, 2024

(51) Int. Cl. B05B 11/00; B65D 50/04

(52) U.S. Cl. CPC B05B 11/0027; B65D 50/04

(57) ABSTRACT

The present invention may comprise a bottle with a top including an interior cap with 12 vanes extending distally towards an axis shared with an outer cap. The plastic cap's vanes are resilient, engaging with a spray nozzle. The interior cap is free to slide or “wiggle” along the length of the outer cap but does not slide out of the outer cap due to four detaining bumps. The outer cap, with the interior cap installed, engages with four L-shaped protrusions such that the four bumps lock with the protrusions to lock the cap to the main body of the cylindrical spray bottle, preventing access to the spray nozzle actuator. This device is designed to deter access to harmful or controlled substances delivered by the spray nozzle by children.

### BACKGROUND OF THE INVENTION

The present invention relates generally to an improved atomizer container system that restricts access to minors.

In some cases, people do not want containers to be easily opened by children or unauthorized individuals when the containers carry a substance that is harmful, controlled, dangerous, or costly.

Some beverages are subject to legal restrictions, such as, most notably, alcoholic beverages. Another type of consumable that is restricted is pharmaceuticals and marijuana-based or hemp-based products. Casual consumption can be dangerous if consumed to excess or without proper use. A chief concern is limiting access to minors (individuals under the local legal age of majority) to avoid harmful consequences. Also, governments institute laws and regulations mandating child-protective barriers to use by minors of controlled substances, such as cannabis and cannabis products.

Liquid dispensing systems comprising a valve assembly and a cooperating actuator may be typically mounted at the top of the container containing the pressurized product. The container, the product, and any propellant in the container, the valve assembly, and the actuator all together may comprise a dispensing package. The actuator typically includes a component that is connected to the valve assembly external of the container and that provides a dispensing flow path or passage from the valve assembly and through which the product can be dispensed to a target area.

For some of these types of fluid dispensing products, the dispensing systems may be provided with a mechanism to render the actuator inoperable when the actuator is locked in a particular position which must be released by the user. This ensures that the product is not dispensed accidentally during shipping or storage when the actuator might be subjected to inadvertent impact. Some dispensing systems can include a hood, overcap, or another cover that prevents the actuator from being actuated unintentionally during shipping or storage until the hood is subsequently removed from the package by the user.

The European Union and the United States maintain regulations as to child-resistant packaging for drugs and other substances. The United States Consumer Product Safety Commission (CPSC) regulated child-resistant packaging based on the Poison Prevention Packaging Act (PPPA). The special packaging requirements under the PPPA are directed towards designing packaging to make it significantly difficult for children under five years old to open the packaging or obtain a toxic or harmful amount of the substance therein within a reasonable amount of time. The requirements also maintain that it should not be difficult for ordinary adults to use the packaging properly. The PPPA requirements do not dictate that the packaging should be designed such that all children cannot open the packaging or obtain a toxic or hazardous amount within a reasonable time. The U.S. child-resistant packaging performance specifications are found in the regulation cited as 16 C.F.R. § 1700.15. The U.S. Food & Drug Administration guidance on child-resistant packaging is available at https://www.fda.gov/media/70788/download as of August 2021. In the United States, individual states usually have their own child-resistant packaging regulations and guidance.

Hand-operated (manual) liquid dispensers of various types have been widely implemented in a variety of applications. One type of liquid dispenser is a manually operated pump arranged to dispense a liquid in a fine mist. Such liquid dispensers are commonly referred to as “atomizers”, in that the liquid is dispensed in tiny liquid droplets. A customary use for such liquid spray dispensers is in the dispensing of fragrance.

Liquid spray dispensers typically utilize a reciprocating pump that is manually operated by an external force (such as depressing with a finger) applied against a restorative or resilient force, such as an expansion spring, with the application and removal of the external force being sufficient to cause pressure changes in a liquid chamber of the dispenser to alternately cause liquid dispensation (e.g., spray) and intake of liquid for the next pumping cycle. Liquid forced under pressure through a spray nozzle may create a dispersed mist of very small liquid droplets. Liquid spray dispensers of this type typically comprise a pump mechanism containing a liquid chamber, and a piston that manually reciprocates in the pump mechanism. The piston is mounted for reciprocating movement within the liquid chamber, such that movement of the pump against a spring force causes the piston to move up and down within the liquid chamber to thereby exert a compression force on the liquid in the chamber. Such force may cause the liquid to move through a liquid passage to the spray outlet (e.g., a nozzle). Release of the external downward force to the pump permits the spring to expand under its restorative force, and to thereby return the pumping mechanism to its extended position. This movement of the pump mechanism causes the piston to move in the liquid chamber in a manner that expands the interior volume of the chamber. The negative pressure created by such movement draws liquid into the liquid chamber. Valve assemblies are typically employed in controlling the flow of liquid into the liquid chamber as its interior volume is increased by the movement of the pump mechanism.

Small atomizers are advantageous for conveniently carrying liquids, such as perfumes, in a pocketbook, pocket, car, etc. The disadvantage to the prior art small atomizers is the need for a top to prevent unwanted dispensing of the liquid.

Thus, it would be advantageous to have a device and a method that prevents minor access for safety and waste control.

As will be seen more fully below, the present invention is substantially different in structure, function, and approach from that of the child-resistant atomizers previously disclosed.

### SUMMARY OF THE INVENTION

In one aspect of the present invention, a cylindrical spray bottle comprises; a main body, an outer cap, an interior cap, and a top includes the interior cap with 12 vanes extending distally towards an axis shared with the outer cap, wherein the vanes are resilient and engage with a spray nozzle, wherein the interior cap is free to slide along the length of the outer cap but does not slide out of the outer cap due to four detaining bumps on the outer cap, and wherein the interior cap engages with four L-shaped protrusions such that the four bumps lock with the protrusions to secure the cap to the main body of the cylindrical spray bottle.

In another aspect of the present invention a liquid atomizer comprises, an actuator, said actuator having; an exterior casing; a locking block, a nozzle, and a piston receiving area having receiving rings and being in liquid communication with said nozzle, a cap, said cap having; an open body having at least one locking flange, said at least one locking flange being dimensioned to enable said locking block to pass over said at least one locking flange by disengagement of a piston within said piston receiving area, a locking channel, said locking channel adjacent to said at least one locking flange and being dimensioned to receive said locking block, at least one stop, a stop channel, said stop channel opposing said locking channel and being adjacent to at least one of said at least one stop, at least one rim, each of said at least one rim having a height less than said at least one locking flange and separating said at least one locking flange from said at least one stop, exterior connection means, and a tube receiving area, a piston unit, said piston unit having, a piston, said piston having a proximal end and a distal end, said proximal end having piston ribs and being dimensioned to be received in said piston receiving area said piston ribs juxtaposing said receiving rings to movably secure said piston proximal end within said piston receiving area while enabling disengagement of said piston ribs within said receiving rings, a spring housing, said spring housing containing a spring mechanism to return said actuator to an extended position, and being dimensioned to be movably received in said tube receiving area, a transfer tube, a body, said body being configured to contain liquid and having; an open first end, said open first end receiving said transfer tube and sealed closed by said spring housing, a sealed second end, interior connection means, said connection means being in locking engagement with said exterior connection means, wherein said nozzle is in liquid communication with said body through said piston unit and compressing said actuator when said locking block is within said locking channel expels liquid contained in said body through said nozzle and rotation of said actuator places said locking block on one of said at least one rim, preventing said actuator from depressing.

In yet another aspect of the invention, a liquid dispensing device, comprised; a container housing a fluid to be dispensed under pressure, the container comprising a dispensing valve provided with a hollow stem through which the fluid is dispensed, a dispensing cap associated with the container, the dispensing cap comprising a base element, a movable element rotatably connected with the dispensing cap, a push-button hinged to the movable element, the push-button comprising a dispensing channel, the dispensing channel including a first end fitted on the hollow stem and a second end comprising a dispensing nozzle, the dispensing cap, engaging with a plurality of L-shaped protrusions such that bumps lock with the protrusions to lock the dispensing cap to the container housing, deterring access to the spray nozzle actuator.

These and other aspects, objects, features, and advantages of the present invention are specifically set forth in or will become apparent from, the following detailed description of an exemplary embodiment of the invention when read in conjunction with the accompanying drawings.

### BRIEF DESCRIPTION OF THE DRAWINGS

FIGS. 1A-1C show some exemplary interchangeable actuators for containers, according to various embodiments of the present invention;

FIG. 2 shows a perspective view of a spray container, according to an embodiment of the present invention;

FIG. 3 shows a cross-section view of a piston element within the interior of a spray container, according to an embodiment of the present invention;

FIG. 4A shows a top view of the piston element shown in FIG. 3, according to an embodiment of the present invention;

FIG. 4B shows a bottom view of the piston element shown in FIG. 3, according to an embodiment of the present invention;

FIG. 5 shows a perspective view of the piston element shown in FIG. 3, according to an embodiment of the present invention;

FIG. 6 shows a side view of a spray nozzle hollow stem unit, according to an embodiment of the present invention;

FIG. 7 shows a perspective view of a piston element, according to yet another embodiment of the present invention;

FIG. 8 shows a perspective view of a container, with an associated overcap, according to a still yet another embodiment of the present invention; and

FIG. 9 shows a posterior view of the overcap shown in FIG. 8.

### DETAILED DESCRIPTION OF THE INVENTION

The following detailed description is of the best currently contemplated modes of carrying out the invention. The description is not to be taken in a limiting sense but is made merely for the purpose of illustrating the general principles of the invention, since the scope of the invention is best defined by the appended claims.

Non-limiting examples of suitable dispensing devices for use herein include aerosol and non-aerosol cans, pumps, sprays, roll-on applicators, lotion pump dispensers, atomizers, and so forth. These devices can be manual or automatic as long as they include the locking and unlocking features of the actuator system of the present invention. Although the actuator system is generally described herein to assist in locking and unlocking the device, the indicia used on the top member and the intermediate member can also be used for other features, such as controlling the volume, intensity, or dispersion of the product being dispensed (e.g., stream vs. spray vs. mist). The product also may be dispensed by a pump (such as for lotion, ointment, liquids, colloids, suspensions), a roll-on applicator, or other suitable manners of dispensing a product from the interior of a container. The indicia can also be used to control different power or modulation settings such as a fast pulse or irregular pulse. Examples of internal pump/aerosol parts which may be used in accordance with the actuator system of the present invention include those devices described in the background of this document, as well as any related devices known in the art.

A liquid atomizer may include an actuator, an outer cap, a piston unit, and a body with an interior liquid chamber. The actuator may comprise an exterior casing, a locking block within the case, a nozzle, and a piston receiving area that is in liquid communication with the nozzle. A tab may extend between the exterior casing and the piston receiving area opposite said nozzle, extending into said stop channel during compression of the actuator.

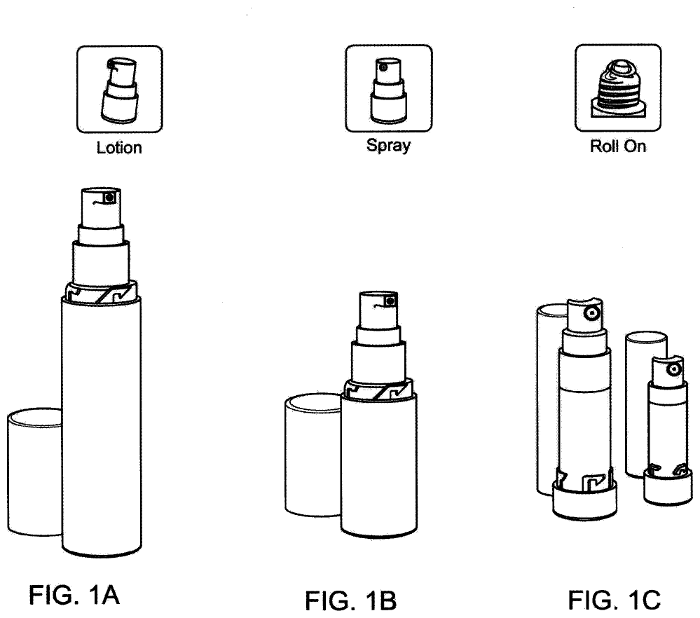

Actuator components may be interchangeable. Some examples of interchangeable actuator components are shown in FIGS. 1A (lotion), 1B (spray), and 1C (roll-on).

The exterior cap may contain an open body having at least one locking flange with an adjacent locking channel. In some embodiments, where only one locking flange is situated to permit rotation in a single direction, the stop extends to the locking channel. In some embodiments, there may be a pair of locking flanges that are separated by the locking channel. The locking channel may be dimensioned to receive the locking block when the actuator is depressed.

In embodiments where two locking flanges are used for bi-directional rotation, a pair of stops, separated by a stop channel opposite the locking channel, may prevent over-rotation of the actuator. In embodiments with a single direction of rotation only, one stop may be sufficient. One, two, or more rims, depending on the number of locking flanges and stops, may separate the locking flanges, and stops. A central tube-receiving area may be dimensioned to receive the piston from the piston unit. When using a plurality of locking flanges, they may extend into the actuator on either side of the locking block and may be dimensioned to prevent the locking block from inadvertent rotation. With a single locking flange, it may extend into the actuator on the side of rotation. Intentional lateral movement to the actuator may rotate the locking block the locking flanges to slide along the rim and contact one of the stops.

The piston unit may house a piston, a spring housing, and a transfer tube. The proximal end of the piston may be dimensioned to be received in the tube receiving area and have ribbing that interacts with rings within the piston receiving area in a juxtaposition manner. The dimensioning between the rings and the piston ribbing permit disengagement, by the piston tilting under the rotational pressure sufficiently to allow the actuator to lift slightly to clear the locking flanges.

The body may be configured to contain liquid with an open first end and a sealed second end. The open first end may receive the transfer tube and may be sealed by the spring housing. One method of sealing the open end of the body is to have interlocking rings on the exterior of the spring housing and the interior of the open end of the body. The interlocking rings permit the spring housing and body to be snapped together to be secured. A vent permits the escaping of air during the snapping action.

To use the atomizer, liquid may be placed inside the body and the transfer tube may be inserted. The spring housing and the body may be snapped, or otherwise sealed together to prevent leakage. The actuator may be depressed, and liquid may be transferred, through the piston to the nozzle. To prevent dispensing of the liquid the actuator may be rotated causing a locking block to contact a locking flange. The application of rotational pressure causes the ribbing at the proximal end of the piston unit to disengage with the rings within the piston receiving area, tilting, and lifting the actuator. This may allow the locking block to pass over the locking flange to rest on the rim with further rotation stopped by the locking block contacting one of the stops. This position may prevent downward movement of the actuator by said locking block contacting said rim.

Various interchangeable actuators are shown in FIGS. 1A, 1B, and 1C, such as lotion actuators, spray actuators, and roll-on actuators. While examples within this application often will refer to spray actuators, it should be understood that the present invention is functional, operational, and inventive as to a range of actuators, including other types not expressly stated herein.

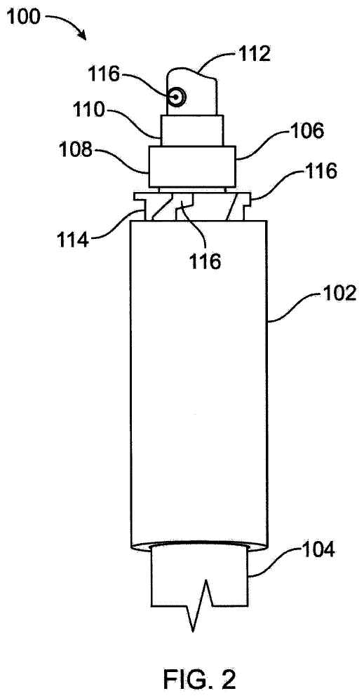

Turning to FIG. 2, a spray container 100 is shown in an exemplary view, with body 102, base 104, and spray actuator 106 placed atop the body 102. Collar 108 may support actuator insert 110 for support of actuator button 112. Between the collar 108 and the top of the body 102, cap engagement support 114 may interact with a cap (not shown), via convex lugs 116 for securing a cap to the spray container 100. The convex lugs 116 may be L-shaped protrusions.

The contents may be transferred from the interior of the spray actuator 100 by depression of the actuator button 112, the contents exiting through nozzle 116 to spray the contents where desired.

The contents may be transferred from the interior of the spray actuator 100 by depression of the actuator button 112, the contents exiting through nozzle 116 to spray the contents where desired.

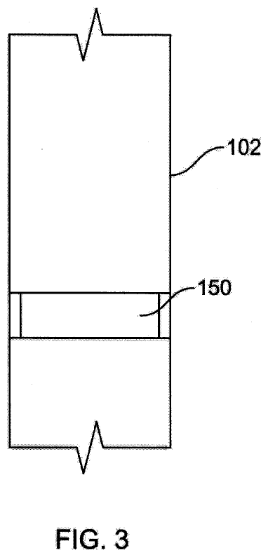

The interior of the body 102, as shown in FIG. 3, may contain a piston 150 situated within an inner diameter inside the body 102, moving or reciprocating under the pressure of the contents toward compression and expansion of the contents of the body 102 to maintain a differential in pressure for expression of the contents, such as a liquid, by spraying through the nozzle 116.

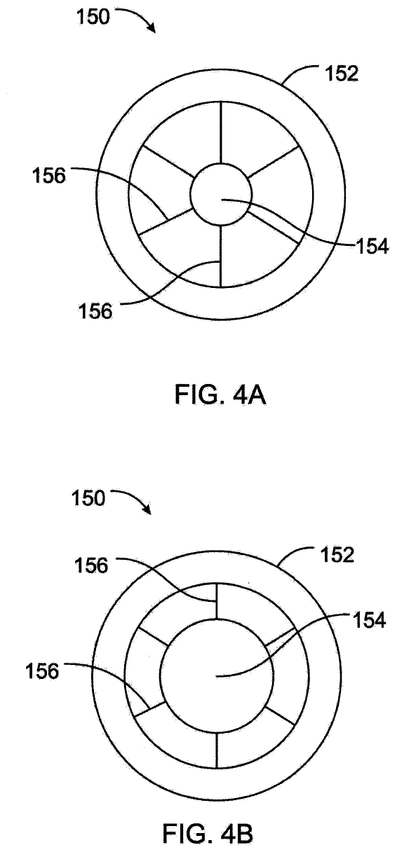

More details regarding the piston 150 are shown in FIGS. 4A and 4B. FIG. 4A depicts a top view of the piston 150, comprising a rim 152, a central hub 154, and vanes 156. The vanes 156 may be of various shapes, such as vanes creating vortices as the piston 150 moves laterally, axially, or rotationally (or a combination of these movements) within the body 102 (shown in FIG. 3). FIG. 4B shows an underside view of the piston shown in FIG. 4A.

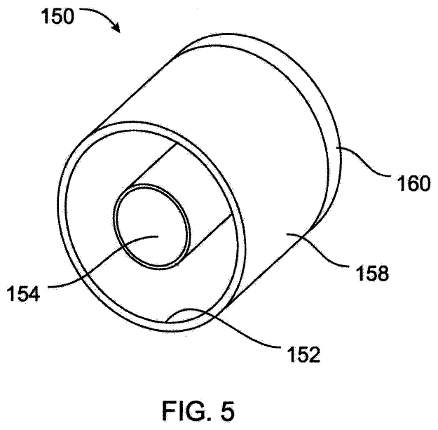

The perspective view of the piston 150 in FIG. 5 shows the respective features of the piston 150, such that the hub 154 is axially protruding a portion of the axial length of the piston 150 inside the body 102, along the longer axis of the body 102. Piston rim 152 is an edge of the piston body 158, with a piston flange 160 situated opposite from the piston rim 152.

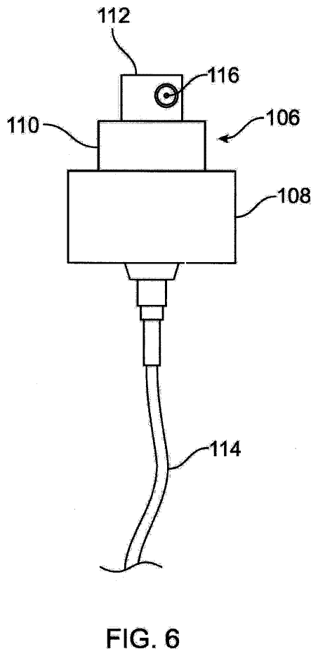

The spray actuator 106 is shown in isolation in FIG. 6. Relating to the spray actuator 106 shown in FIG. 2, the view in FIG. 6 shows the transfer tube 114 in fluid communication with the nozzle 116 wherein the contents, of the body 102 (shown in FIG. 1), such as a liquid, may be urged through the interior of the transfer tube 114 and sprayed outward through the nozzle 116.

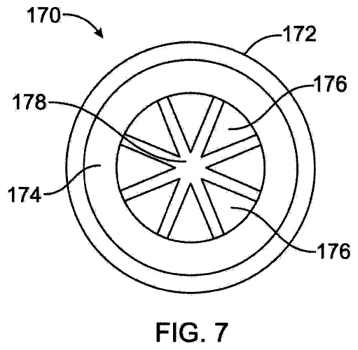

Another embodiment of a piston 170 is shown in FIG. 7. The piston 170 may comprise a piston rim 172, banked surface 174, with multiple vanes 176, perhaps 12 vanes 176, with a central hub 178 for exerting a varied movement of the contents under pressure as the piston 170 moves laterally, axially, or rotationally (or a combination of these movements) within the body 102 (shown in FIG. 2).

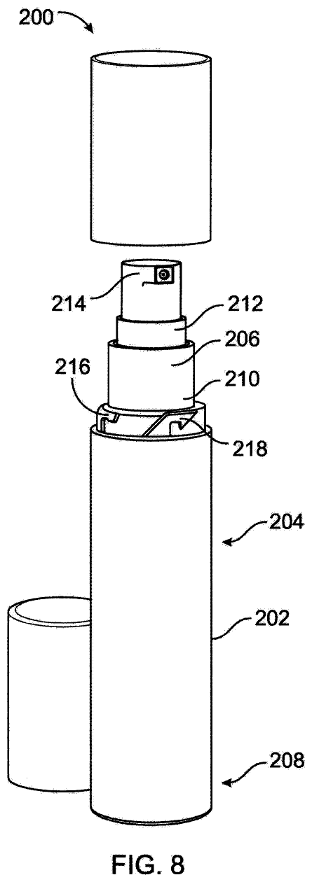

An overcap 200, as shown in FIG. 8, may be used to cover the actuator, such as the spray actuator 100 from FIG. 2. The overcap 200 may engage with a body 202 of a container 204 securely to prevent the actuator 206 from being actuated unintentionally during shipping or storage until the overcap 200 is subsequently removed from the container 204 by the user.

Engaged with the body 202, may be a base 208, and an actuator 206 placed atop the body 202. Collar 210 may support actuator insert 212 for support of actuator button 214. Between the collar 210 and the top of the body 202, cap engagement support 216 may interact with the overcap 200, via convex lugs 218 for securing the overcap 200 to container 204. The convex lugs 218 may be L-shaped protrusions.

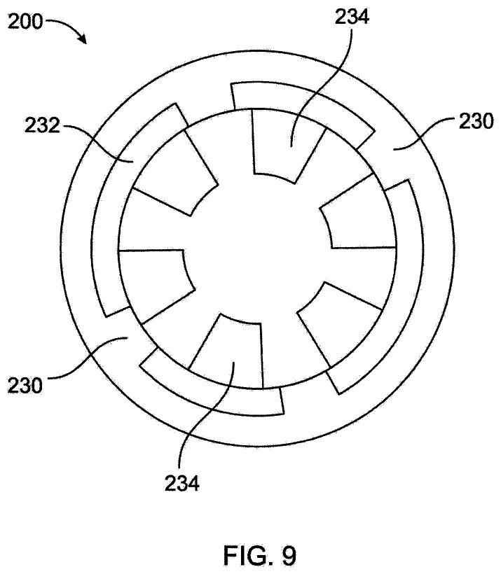

Referring to FIG. 9, a posterior view of the overcap 200 of FIG. 8 to show the structure, including the structure to mate the overcap 200 in engagement with the convex lugs 218 (shown in FIG. 8) and other portions of the container 204 (shown in FIG. 8).

A plurality of retaining tabs 230 extend toward a longitudinal axis of the overcap 200 interior for sliding engagement and disengagement with the convex lugs 218 (shown in FIG. 8). A form-fitting gasket 232 may be force fit into the interior circumference of the overcap 200, retained by detents and/or the retaining tabs 230. The form-fitting gasket 232 may include at a distal end a plurality of vanes 234, such as six vanes 234 for receiving the distal end of the actuator button 112 (shown in FIG. 2). The vanes 234 may serve to support the actuator button to allow it some tolerance for movement along the axial direction without inadvertently depressing the actuator button to dispense product when the overcap 200 is secured to cover the actuator 206 (shown in FIG. 8).

The apparatuses and methods described herein may be modified or altered to comprise more aspects, concurrent steps, simultaneous steps, or other variations.

It should be understood, of course, that the foregoing relates to exemplary embodiments of the invention and that modifications may be made without departing from the spirit and scope of the invention as set forth in the following claims. Furthermore, a method herein described may be performed in one or more sequences other than the sequence presented expressly herein.

Skilled artisans may implement the described functionality in varying ways for each particular application, but such implementation decisions should not be interpreted as causing a departure from the scope of the present invention.

The word “exemplary” is used exclusively herein to mean “serving as an example, instance, or illustration.” Any embodiment described herein as “exemplary” is not necessarily to be construed as preferred or advantageous over other embodiments.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” and such simply denote different singles of a plurality and do not imply any order or sequence unless specifically defined by the claim language. The sequence of the text in any of the claims does not imply that steps must be performed in a temporal or logical order according to such sequence unless it is specifically defined by the language of the claim. The steps may be interchanged in any order without departing from the scope of the invention as long as such an interchange does not contradict the claim language and is not logically nonsensical.

Furthermore, depending on the context, two elements may be connected to each other physically or in any other manner, through one or more additional elements.

While at least one exemplary embodiment has been presented in the foregoing detailed description, it should be appreciated that a vast number of variations exist. It should also be appreciated that the exemplary embodiments are only examples, and are not intended to limit the scope, applicability, or configuration of the invention in any way. Rather, the foregoing detailed description will provide those skilled in the art with a convenient road map for implementing the exemplary embodiments. It should be understood that various changes can be made in the function and arrangement of elements without departing from the scope of the invention as set forth in the appended claims and the legal equivalents thereof.

1. A cylindrical spray bottle, comprising:
a main body;
an outer cap;
an interior cap; and
a top includes the interior cap with 12 vanes extending distally towards an axis shared with the outer cap;
wherein the vanes are resilient and engage with a spray nozzle;
wherein the interior cap is free to slide along the length of the outer cap but does not slide out of the outer cap due to four detaining bumps on the outer cap; and
wherein the interior cap engages with four L-shaped protrusions such that the four bumps lock with the protrusions to secure the cap to the main body of the cylindrical spray bottle.

2. The cylindrical spray bottle of claim 1, further comprising radially extending projections inside the interior cap.

3. The cylindrical spray bottle of claim 1, wherein the outer cap and the interior cap are cylindrical in shape.

4. The cylindrical spray bottle of claim 1, wherein each of the L-shaped protrusions comprises a projection that extends from an outer surface of a cap engagement support and comprises a catch edge situated between the outer surface of the cap engagement support and an inner surface of the outer cap to engage with protrusions on the inner surface of the outer cap to secure the outer cap to the spray bottle.

5. A liquid atomizer comprising:
an actuator, said actuator having:
an exterior casing:
a locking block;
a nozzle; and
a piston receiving area having receiving rings and being in liquid communication with said nozzle;
a cap, said cap having:
an open body having at least one locking flange, said at least one locking flange being dimensioned to enable said locking block to pass over said at least one locking flange by disengagement of a piston within said piston receiving area;
a locking channel, said locking channel adjacent to said at least one locking flange and being dimensioned to receive said locking block;
at least one stop;
a stop channel; said stop channel opposing said locking channel and being adjacent to at least one of said at least one stop;
at least one rim, each of said at least one rim having a height less than said at least one locking flange and separating said at least one locking flange from said at least one stop;
exterior connection means; and
a tube receiving area;
a piston unit, said piston unit having:
a piston, said piston having a proximal end and a distal end, said proximal end having piston ribs and being dimensioned to be received in said piston receiving area said piston ribs juxtaposing said receiving rings to movably secure said piston proximal end within said piston receiving area while enabling disengagement of said piston ribs within said receiving rings;
a spring housing, said spring housing containing a spring mechanism to return said actuator to an extended position, and being dimensioned to be movably received in said tube receiving area;
a transfer tube,
a body, said body being configured to contain liquid and having:
an open first end, said open first end receiving said transfer tube and sealed closed by said spring housing;
a sealed second end;
interior connection means, said connection means being in locking engagement with said exterior connection means; wherein said nozzle is in liquid communication with said body through said piston unit and compressing said actuator when said locking block is within said locking channel expels liquid contained in said body through said nozzle and rotation of said actuator places said locking block on one of said at least one rim, preventing said actuator from depressing.

6. A liquid dispensing device, comprising:
a container housing a fluid to be dispensed under pressure;
the container comprising a dispensing valve provided with a hollow stem through which the fluid is dispensed;
an overcap associated with the container, the overcap comprising a base element;
a movable element rotatably connected with the overcap;
a push-button hinged to the movable element, the push-button comprising a dispensing channel, the dispensing channel including a first end fitted on the hollow stem and a second end comprising a dispensing nozzle;
the overcap, engaging with a plurality of L-shaped protrusions such that bumps lock with the protrusions to lock the overcap to the container housing, deterring access to the spray nozzle actuator.

7. The liquid dispensing device of claim 6, further comprising a form-fitted gasket force fit into the interior circumference of the overcap, retained by retaining tabs.

8. The liquid dispensing device of claim 7, further comprising vanes at the distal end of the interior of the overcap.
